(19) United States
(12) Patent Application Publication
(10) Pub. No.: US 2014/0227389 A1
(43) Pub. Date: Aug. 14, 2014

(54) MULTI-REGION CONFECTIONERY AND METHOD OF PRODUCTION THEREOF

(71) Applicant: MONDELEZ JAPAN LIMITED, Shingawa-ku, Tokyo (JP)

(72) Inventors: Takaya Koseki, Kanagawa (JP); Hideki Sakanishi, Kanagawa (JP)

(73) Assignee: MONDELEZ JAPAN LIMITED, Shingawa-ku, Tokyo (JP)

(21) Appl. No.: 14/345,709

(22) PCT Filed: Sep. 17, 2012
(86) PCT No.: PCT/IB2012/054906

§ 371 Date: Mar. 19, 2014

Related U.S. Application Data
(60) Provisional application No. 61/536,652, filed on Sep. 20, 2011.

(30) Foreign Application Priority Data
Nov. 4, 2011 (GB) 1119039.4

(51) Int. Cl. A23G 3/54; A23G 4/20

(52) U.S. Cl. CPC A23G 3/545; A23G 4/205
USPC 426/5; 426/103; 426/282

(57) ABSTRACT

A multi-region confection includes a first and a second confectionery material. The body portion of the multi-region confection includes an extruded first confectionery material, and a plurality of capillaries is disposed in the extruded body portion. The plurality of capillaries includes the second confectionery material. The second confectionery material includes about 47 to about 95 weight percent of a sugar alcohol, about 1 to about 15 weight percent water, and about 0.1 to about 1.5 weight percent of a slow-set pectin; wherein all weight percent values are based on the total weight of the second confectionery material. A method of making the multi-region confection is also described.

### BACKGROUND OF THE INVENTION

It is desirable to produce confectionery products formed of different components, so as to increase sensory pleasure. A number of confectionery products exist, which have multiple regions formed of different components. For example, multi-layer confectionery products can include multiple layers of different confectionery components stacked one above another. Center-filled confectionery compositions are also known, which comprise a core (or center-fill) confectionery component and a shell confectionery component surrounding the core component. Also known are coated confectionery compositions, which comprise a coating of one confectionery component over another confectionery component. The presence of different components increases sensory pleasure by providing a variety of flavors and textures to a consumer.

International Publication No. WO 2007/056685A2 of Formaguera discloses a variety of center-filled confectionery products, which comprise a center-filled confectionery rope located within the body of another confectionery component. International Publication No. WO 2010/034980A1 of Vaman et at discloses a multi-region confectionery product, which comprises a first confectionery material in the form of an extruded body portion and a plurality of capillaries disposed in the extruded body portion. When making confectionery products comprising a plurality of capillaries disposed in the body of the confectionery, a number of difficulties are encountered. For example, the capillary forming material often leaks out of the multi-region confection. Sometimes, the capillary forming confectionery material gets struck in the extrusion apparatus. Some capillary forming confectionery materials form irregular shapes, and therefore are unappealing to consumers. Further, some capillary forming confectionery materials become very hard crystals, thereby becoming unpalatable to consumers.

There is demand for providing multi-region confectionery products, which include well-defined, uniform looking capillaries disposed in the body of the product. It is also desirable to prevent or reduce leakage of capillary forming material from the body during the manufacturing process of the multi-region confectionery products. The capillary forming material of desirable multi-region confectionery products should provide distinctive taste or texture as compared to the body of the confectionery products. It is further desired that the multi-region confection provide cooling sensation. Some cooling agents are harsh and bitter, while other may not be compatible with capillary formation process. The challenge lies in achieving a balance of crunchy texture, sweetness and cooling sensation without or with reduced bitterness. The embodiments of the present invention address the demand, the challenge and provide desirable multi-region confections.

### BRIEF DESCRIPTION OF THE INVENTION

One embodiment is a multi-region confection comprising an extruded body portion comprising a first confectionery material; and a plurality of capillaries disposed in the extruded body portion and comprising a second confectionery material comprising about 47 to about 95 weight percent of a sugar alcohol, about 1 to about 15 weight percent water, and about 0.1 to about 1.5 weight percent of a pectin having a degree of methoxylation of about 50 to about 70 percent, wherein all weight percent values are based on the total weight of the second confectionery material, unless a different weight basis is specified.

Another embodiment is a method of forming a multi-region confection, comprising extruding a first confectionery material to form an extruded body portion and a plurality of capillaries disposed in the extruded body portion; and extruding a second confectionery material into at least one of the plurality of capillaries; wherein the second confectionery material comprises about 47 to about 95 weight percent of a sugar alcohol, about 1 to about 15 weight percent water, and about 0.1 to about 1.5 weight percent of a pectin having a degree of methoxylation of about 50 to about 70 percent, wherein all weight percent values are based on the total weight of the second confectionery material, unless a different weight basis is specified.

Yet another embodiment is a confectionery composition comprising about 47 to about 95 weight percent of a sugar alcohol; about 1 to about 15 weight percent water; and about 0.1 to about 1.5 weight percent of a pectin having a degree of methoxylation of about 50 to about 70 percent; wherein all weight percent values are based on the total weight of the confectionery composition, unless a different weight basis is specified.

### BRIEF DESCRIPTION OF THE DRAWINGS

Referring now to the drawings wherein like elements are numbered alike in several FIGURES:

FIG. 1 is a schematic diagram illustrating the apparatus used for preparing various examples of multi-region confections;

FIG. 2 is a schematic diagram illustrating the extrusion die assembly used together with the apparatus of FIG. 1 for preparing various multi-region confections;

FIG. 3 is a picture of the micro-capillary die used for preparing various multi-region confections.

### DETAILED DESCRIPTION OF THE INVENTION

The invention includes at least the following embodiments.

In some embodiments, there is provided a multi-region confection comprising an extruded body portion comprising a first confectionery material; and a plurality of capillaries disposed in the extruded body portion and comprising a second confectionery material. The present inventors surprisingly found that while making a multi-region confection adding a slow-set pectin to the second confectionery material surprisingly prevents or reduces leaking of the second confectionery material from the body portion comprising of the first confectionery material. Addition of the pectin surprisingly improves the appearance to the capillaries formed out of the second confectionery material. These capillaries appear well formed, and cracking or breaking of capillaries is reduced. It was surprisingly found that the pectin containing confectionery material was easier to form into capillaries since it greatly reduced clogging of the capillary die. Further, addition of the pectin surprisingly enhanced the crunchy texture of the confectionery material.

Pectin contains galacturonic acid residues. The galacturonic acid residues may be esterified with methanol. The degree of methoxylation or methylation (DM) of pectins is defined as the percentage of carbonyl groups esterified with methanol. As used herein the term “high-methoxy pectin” refers to pectin having a degree of methoxylation of about 50 to about 70 percent. The term “slow-set pectin” includes high-methoxy pectin. Slow-set pectins typically gel at a pH of less than 4 and solids content of above 50% in the solution.

It has been surprisingly found by the inventors that high-methoxy pectin is particularly more advantageous as compared to low-methoxy pectins. It is also surprisingly found that high-methoxy pectin when present in the amounts of about 0.1 to about 1.5 weight percent of the second confectionery material reduces the problems associated with preparation of multi-region confections described earlier. Amounts lower than about 0.1 weight percent are not capable of providing gelling properties to the second confectionery material, while amounts higher than about 1.5 weight percent cause blocking of the capillary die.

It has been surprisingly found that slow-set pectin was particularly advantageous for addressing the problems faced during preparation of multi-region confections. As opposed to slow-set pectin, rapid-set pectin creates a number of operational difficulties. It is very difficult to control set time and solidification of capillary components comprising rapid-set pectin. Rapid-set pectin causes blockage of capillary die and uneven gelling of confectionery components.

In some embodiments, there is provided a multi-region confection comprising an extruded body portion comprising a first confectionery material; and a plurality of capillaries disposed in the extruded body portion and comprising a second confectionery material comprising about 47 to about 95 weight percent of a sugar alcohol, about 1 to about 15 weight percent water, and about 0.1 to about 1.5 weight percent of a slow-set pectin, wherein all weight percent values are based on the total weight of the second confectionery material, unless a different weight basis is specified. Within the range of about 1 to about 15 weight percent, the water can be about 3 to about 13 weight percent, specifically the water can be about 5 to about 11 weight percent. The water amounts mentioned herein are amounts in the final multi-region confectionery product. The water amounts can be higher during the process of making the multi-region confectionery product.

Within the range of about 0.1 to about 1.5 weight percent, the slow-set pectin can be about 0.2 to about 1.3 weight percent, specifically, the slow-set pectin can be about 0.3 to about 1.1 weight percent. In some embodiments, the slow-set pectin is a pectin having a degree of methoxylation of about 50 to about 70 percent. Within the range of about 50 to about 70 percent, the degree of methoxylation of the slow-set pectin can be about 54 to about 66 weight percent, specifically about 57 to about 63 weight percent.

The second confectionery material of the multi-region confection can comprise of any suitable sugar alcohol. In some embodiments, the sugar alcohol is selected from the group consisting of erythritol, xylitol, mannitol, galactitol, maltitol, hydrogenated isomaltulose (isomalt), sorbitol, lactitol, hydrogenated starch hydrolysate, and combinations thereof. The second confectionery material comprises about 47 to about 95 weight percent of a sugar alcohol. Within the range of about 47 to about 95 weight percent, the sugar alcohol can be about 75 to about 91 weight percent, specifically about 79 to about 87 weight percent.

In some embodiments, the sugar alcohol comprises a mixture of erythritol and xylitol. It has been surprisingly found by the present inventors that a mixture of erythritol and xylitol provides a pleasant cooling sensation without bitterness. The mixture also provides a crunchy texture to the second confectionery material. The mixture may comprise erythritol to xylitol in a ratio of about 10:90 to about 90:10, wherein the ratios are based on weight of the sugar alcohols in the mixture. Within the range of about 10:90 to about 90:10, the weight ratio of erythritol to xylitol can be about 30:70 to about 70:30, specifically the weight ratio can be about 40:60 to about 60:40, more specifically the weight ratio can be about 45:55 to about 55:45.

In some embodiments, the second confectionery material further comprises about 1 to about 50 weight percent of a food-grade fat or oil, based on the total weight of the second confectionery material. Within the range of about 1 to about 50 weight percent, the amount of food-grade fat or oil can be about 2 to about 30 weight percent, specifically about 3 to about 20 weight percent, more specifically about 4 to about 10 weight percent. In some embodiments, the food-grade fat or oil can be about 4 to about 6 weight percent.

In some embodiments, the food-grade fat or oil is selected from the group consisting of partially or fully hydrogenated vegetable oil, partially or fully hydrogenated animal fat, a glyceride, and combinations thereof. In some embodiments, the partially or fully hydrogenated oil or fat is selected from the group consisting of partially or fully hydrogenated coconut oil, partially or fully hydrogenated corn oil, partially or fully hydrogenated palm kernel oil, partially or fully hydrogenated peanut oil, partially or fully hydrogenated soy bean oil, partially or fully hydrogenated sesame oil, partially or fully hydrogenated cottonseed oil, partially or fully hydrogenated cocoa butter, partially or fully hydrogenated milk fat, partially or fully hydrogenated beef tallow, partially or fully hydrogenated lard, and combinations thereof. In some embodiments, the food grade fat is a fat of vegetable origin, such as that commercially available under the trade name N'ICE 368 from Premium Vegetable Oils Sdn. Bhd, Kuala Lumpur, Malaysia.

The food-grade fat or oil can have a suitable melting point so as to be compatible with the process of making the multi-region confection. In some embodiments, the oil or fat has a melting point of about 30° C. to about 80° C. Within the range of about 30° C. to about 80° C., the melting point can be in the range of about 35° C. to about 70° C., specifically about 40° C. to about 65° C.

A suitable food-grade fat or oil having a suitable melting point and weight percentage of the fat or oil can be chosen depending upon the desired texture of the multi-region confection. The melting point of the food-grade fat or oil can affect hardness or crispiness, while the weight percent of the fat or oil can affect the time the capillary component takes to melt in mouth.

In some embodiments, the second confectionery material further comprises an emulsifier in an amount of about 5 to about 20 weight percent, based on the weight of the food grade fat or oil. Within the range of about 5 to about 20 weight percent, the emulsifier amount can be about 7 to about 15 weight percent, specifically about 8 to about 13 weight percent, more specifically about 10 to about 12 weight percent.

Suitable emulsifiers include glyceryl monostearate, lecithin, fatty acid monoglycerides, fatty acid diglycerides, propylene glycol monostearate, and combinations thereof. In some other embodiments, the emulsifier comprises a sugar ester, a polyglycerol fatty acid ester, a polyglycerol polyricinoleate (PGPR), a polysorbate (e.g. polyoxyethylene sorbitan ester), sodium stearoyl lactylate (SSL), a monoglyceride or a combination thereof.

The multi-region confection can, optionally, further comprise a food-grade acid. The first confectionery material or the second confectionery material can comprise the food-grade acid. Suitable food-grade acids include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and combinations thereof. The first or the second confectionery material can also comprise salts of the foregoing acids.

The amount of the food-grade acid, when present, can be about 1 to about 20 weight percent based on the total weight of the second confectionery material. Within the range of about 1 to about 20 weight percent, the food grade acid amount can be about 2 to about 15 weight percent, specifically about 3 to about 10 weight percent, even more specifically about 4 to about 8 weight percent.

The first confectionery material of the multi-region confection can be any suitable confectionery composition. In some embodiments, the first confectionery material is a hard-boiled candy composition. Hard-boiled candies, also known as hard sweets or boiled sweets, are solids and essentially amorphous confectionery products obtained by extensive dehydration of carbohydrate syrups. Hard-boiled candies can be sugar based or sugar free.

In some other embodiments, the first confectionery material is a chewy candy composition. Chewy candy means those confections with soluble components that allow a consumer to experience a chew texture with elasticity for a chew period of more than one minute. Chewy candies typically include bulk sweeteners, gelling agents, and fats. They can optionally include chew texture modifying agents to modify the chew texture.

In yet other embodiments, the first confectionery material is a chewing gum composition. Chewing gums typically contain a water-insoluble gum base, sweeteners, flavors, and a variety of additional ingredients tailored to provide specific release characteristics.

In some embodiments, the multi-region confection further comprises one or more additives, such as sweetening agents, flavor modulators and potentiators, flavorants, aroma agents, coolants, warming agents, coloring agents, breath fresheners, mouth moisteners, humectants, acidulants, buffering agents, tingling agents, oral care agents, throat care agents, medicaments, antioxidants, preservatives, and combinations thereof. The additives can be present in the first confectionery material and/or the second confectionery material.

The first and/or the second confectionery materials of the multi-region confection can further comprise of one or more sweetening agents in addition to the sugar alcohol of the second confectionery material. Sweetening agents can include sugar sweeteners, sugarless sweeteners, high intensity sweeteners, or a combination of at least two of the foregoing sweetening agents.

Sugar sweeteners generally include saccharides. Suitable sugar sweeteners include monosaccharides, disaccharides, and polysaccharides such as sucrose (sugar), dextrose, maltose, dextrin, xylose, ribose, glucose, mannose, galactose, fructose (levulose), lactose, invert sugar, fructooligosaccharide syrups, partially hydrolyzed starch, corn syrup solids, high fructose corn syrup, and combinations thereof.

Suitable sugarless sweeteners include sugar alcohols (or polyols) such as sorbitol, xylitol, mannitol, galactitol, maltitol, hydrogenated isomaltulose (isomalt), lactitol, erythritol, hydrogenated starch hydrolysate, and combinations thereof. Suitable hydrogenated starch hydrolysates include those disclosed in U.S. Pat. No. 4,279,931 to Verwaerde et al. and various hydrogenated glucose syrups and/or powders, which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates are commercially available, such as LYCASIN™, a line of commercially available products manufactured by Roquette Freres of France, and HYSTAR™, a line of commercially available products manufactured by Lonza, Inc., of Fair Lawn, N.J., USA.

A “high intensity sweetener” as used herein means agents having a sweetness at least 100 times that of sugar (sucrose) on a per weight basis, specifically at least 500 times that of sugar on a per weight basis. In some embodiments the high intensity sweetener is at least 1,000 times that of sugar on a per weight basis, more specifically at least 5,000 times that of sugar on a per weight basis. The high intensity sweetener can be selected from a wide range of materials, including water-soluble natural and artificial sweeteners, derivatives of water-soluble natural and artificial sweeteners, dipeptide based sweeteners, and protein based sweeteners. Any combination comprising two or more high intensity sweeteners can also be used. One or more of the high intensity sweeteners can further be combined with one or more of the foregoing sweeteners or sweetening agents.

The high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, and combinations of the foregoing forms.

Without being limited to particular sweetening agents, representative categories and examples include (1) water-soluble sweetening agents such as dihydrochalcones, monellin, steviosides, Rebaudioside A, Rebaudioside B, Rebaudioside C, glycyrrhizin, dihydroflavenol, and sugar alcohols such as sorbitol, mannitol, maltitol, monatin, and L-aminodicarboxylic acid aminoalkenoic acid ester amides, such as those disclosed in U.S. Pat. No. 4,619,834 to Zanno et al., or a combination comprising at least one of the foregoing; (2) water-soluble artificial sweeteners such as saccharin, soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination comprising at least one of the foregoing; (3) dipeptide based sweeteners, for example the L-aspartic acid derived sweeteners such as L-aspartyl-L-phenylalanine methyl ester (Aspartame) and materials described in U.S. Pat. No. 3,492,131 to Schlatter et al., L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenyl-glycine, L-alpha-aspartyl-L-phenylglycine methyl ester, L-alpha-aspartyl-L-2,5-dihydrophenylglycine methyl ester, L-aspartyl-2,5-dihydro-L-phenylalanine; L-alpha-aspartyl-2,5-dihydrophenylalanine methyl ester, L-aspartyl-L-(1-cyclohexen)-alanine, N—(N-(3,3-dimethylbutyl)-L-alpha-aspartyl)-L-phenylalamine methyl ester (Neotame), or a combination thereof; (4) derivatives of naturally occurring water-soluble sweeteners, such as derivatives of steviosides, derivatives of Rebaudioside A, derivatives of Rebaudioside B, derivatives of Rebaudioside C, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chloro deoxygalactosucrose derivatives include 1-chloro-1′-deoxysucrose; 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose; 1,6-dichloro-1,6-dideoxy-β-D-fructofuranosyl-4-chloro-4-deoxy-α-D-galactopyranoside; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; 4,6,1′,6′-tetradeoxy-sucrose, or a combination thereof; (5) protein based sweeteners such as thaumaoccous danielli, thaumatin, talin, and combinations thereof.

In some embodiments, the sweeteners include sorbitol, mannitol, aspartame, acesulfame potassium salt, and combinations thereof.

In a multi-region confectionery product, a sweet taste can also come from flavor modulators or potentiators and/or from flavorants. Flavor modulators can impart a characteristic of their own that complements or negates a characteristic of another component. For example, flavors can be compounded to have additional sweet notes by the inclusion of flavor modulators or potentiators, such as vanilla, vanillin, ethyl maltol, furfural, ethyl propionate, lactones, and a combinations thereof. The flavor modulators can be used in the amount about 0.01 to about 30 weight percent of the first and/or second confectionery material depending on the desired intensity of the aromas used. Preferably, the content of the flavor modulators is in the range of about 0.2 to about 3 weight percent of the first and/or second confectionery material.

Flavor potentiators are materials that intensify, supplement, modify or enhance the taste or aroma perception of an original material without introducing a characteristic taste or aroma perception of their own. In some embodiments, flavor potentiators are designed to intensify, supplement, modify, or enhance the perception of flavor, sweetness, tartness, umami, kokumi, saltiness or a combination thereof. The flavor potentiators can be used in the amount about 0.01 to about 30 weight percent of the first and/or the second confectionery composition depending on the desired intensity of the aromas used. Preferably, the content of the flavor potentiators is in the range of about 0.2 to about 3 weight percent of the first and/or the second confectionery composition.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, phyllodulcin, vanilla extract, vanilla oleoresin, vanillin, sugar beet extract (alcoholic extract), sugarcane leaf essence (alcoholic extract), compounds that respond to G-protein coupled receptors (T2R5 and T1R5), and combinations thereof. In some embodiments, sugar acids, sodium chloride, potassium chloride, sodium acid sulfate, or a combination comprising at least one of the foregoing are used. In other embodiments, glutamates such as monosodium glutamate, monopotassium glutamate, hydrolyzed vegetable protein, hydrolyzed animal protein, yeast extract, and combinations thereof are included. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

Flavorants (also known as flavorings, flavors or flavoring agents) that can be used include those artificial and natural flavors known in the art, for example synthetic flavor oils, natural flavoring aromatics and/or oils, oleoresins, extracts derived from plants, leaves, flowers, fruits, and the like, and combinations comprising at least one of the foregoing flavorants. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, and combinations thereof. Specific flavorants are mints such as peppermint, spearmint, artificial vanilla, cinnamon derivatives, and various fruit flavors.

Examples of artificial, natural, and synthetic fruit flavorants include coconut, coffee, chocolate, vanilla, lemon, grapefruit, orange, lime, yazu, sudachi, menthol, licorice, caramel, honey, peanut, walnut, cashew, hazelnut, almonds, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and the like, and combinations thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), 2-dodecenal (citrus, mandarin), and combinations thereof.

Other potential flavors whose release profiles can be managed include a milk flavor, a butter flavor, a cheese flavor, a cream flavor, a yogurt flavor, a vanilla flavor, a tea or coffee flavor, such as a green tea flavor, a oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, zanthoxyli fructus, perilla, juniper berry, ginger, star anise, horseradish, thyme, a tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, tomato, and any combinations thereof. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the first and/or second confectionery material can further include fruit juices.

The flavoring agents can be used in many distinct physical forms. Such physical forms include liquid and/or dried form. In some embodiments, the flavoring agents can be in free (unencapsulated) forms, spray dried forms, freeze dried forms, powdered forms, beaded forms, encapsulated forms, slices, pieces, and mixtures thereof. When employed in a spray-dried form, suitable drying means such as spray-drying a liquid can be used. Alternatively, the flavoring agent can be absorbed onto water-soluble materials, such as cellulose, starch, sugar, maltodextrin, gum arabic and so forth or it can be encapsulated. In still other embodiments, the flavoring agent can be adsorbed onto silicas, zeolites, and the like. The particle size of the flavoring agents can be less than 3 millimeters, less than 2 millimeters or preferably less than 1 millimeter, calculated as the longest dimension of the particle. The natural flavoring agent can have a particle size about 3 micrometers to 2 millimeters, specifically about 4 micrometers to about 1 millimeter. The flavorants can be used in the amount about 0.01 to about 30 weight percent of the first confectionery material and/or the second confectionery material, depending on the desired intensity of the aromas used. Preferably, the content of the flavorants is in the range of about 0.2 to about 3 weight percent of the first confectionery material and/or the second confectionery material.

The amount of flavor modulators, flavor potentiators, and flavorants used herein can be a matter of preference subject to such factors as the type of final multi-region confection, the individual flavor, and the strength of flavor desired. Thus, the amount of flavorants can be varied in order to obtain the result desired in the final product and such variations are within the capabilities of those skilled in the art without the need for undue experimentation.

In some embodiments, the first and/or second confectionery material of the multi-region confection contains aroma agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The aroma agents can be in liquid or powdered form. The aroma agents can be used in the amount about 0.01 to about 30 weight percent of the first and/or second confectionery material depending on the desired intensity of the aromas used. Preferably, the content of the aroma agents is in the range of about 0.2 to about 3 weight percent of the first and/or second confectionery material.

Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2-propyl)-5-methyl-1-cyclohexanol) is available in artificial form, or naturally from sources such as peppermint oil. Menthol derivatives include menthyl ester-based and menthyl carboxamide-based cooling compounds such as menthyl carboxamide, N-ethyl-p-menthane carboxamide, monomenthyl succinate, monomenthyl methyl succinate, monomenthyl glutarate, menthyl 2-pyrrolidone-5-carboxylate, monomenthyl 3-methyl maleate, menthyl acetate, menthyl lactate, menthyl salicylate, 2-isopropanyl-5-methylcyclohexanol, 3-L-menthoxypropane-1,2-diol, menthane, menthone, menthone ketals, menthone glycerol ketals, menthyl glutarate esters, N-ethyl-p-menthane-3-carboxamide (WS-3), or a combination thereof. Additional menthyl-based coolants, specifically menthyl carboxamides, are described in U.S. Pat. No. 7,923,577 to Bardsley et al.

Other cooling agents that can be used in combination with or in the absence of the menthyl-based coolants include, for example 2-mercapto-cyclo-decanone, hydroxycarboxylic acids with 2 to 6 carbon atoms, xylitol, erythritol, alpha-dimethyl succinate, menthyl lactate, acyclic carboxamides such as N-2,3-trimethyl-2-isopropyl butanamide, and combinations thereof. Additional cooling agents include the 1-tert-butylcyclohexanecarboxamides described in U.S. Patent Application Publication Nos. US 2011/0070171 A1 and US 2011/0070329 A1 of Kazimierski et al. Cooling compositions comprising a primary cooling compound, a secondary cooling compound, and an ingestible non-polar solvent are described in U.S. Patent Application Publication No. US 2011/0091531 A1 of Furrer et al. Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumary Company Limited, Tokyo, Japan, vanillyl alcohol methyl ether, vanillyl alcohol ethyl ether, vanillyl alcohol n-propyl ether, vanillyl alcohol isopropyl ether, vanillyl alcohol isobutyl ether, vanillyl alcohol n-pentyl ether, vanillyl alcohol isoamyl ether, vanillyl alcohol n-hexylether, gingerol, shogaol, paradol, zingerone, capsaicin, dihydrocapsaicin, nordihydrocapsaicin, homocapsaicin, homodihydrocapsaicin, ethanol, isopropyl alcohol, isoamyl alcohol, benzyl alcohol, glycerin, and combinations thereof.

Coloring agents (also known as colorants or colorings) can be used in amounts effective to produce a desired color for the confectionery material. Suitable coloring agents include pigments, which can be incorporated in amounts up to about 6 weight percent by weight of the first and/or second confectionery material. For example, titanium dioxide can be incorporated in amounts up to about 2 weight percent and specifically less than about 1 weight percent by weight of the first and/or second confectionery material. Suitable coloring agents also include natural food colors and dyes suitable for food, drug, and cosmetic applications.

Suitable colorants include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), FD&C aluminum lakes, and combinations thereof.

Exemplary breath fresheners include zinc citrate, zinc acetate, zinc fluoride, zinc ammonium sulfate, zinc bromide, zinc iodide, zinc chloride, zinc nitrate, zinc fluorosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, and combinations thereof. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, and combinations thereof. Aldehydes such as cinnamic aldehyde and salicylaldehyde can be used. Additionally, chemicals such as menthol, carvone, iso-garrigol, and anethole can function as breath fresheners.

Exemplary mouth moisteners include saliva stimulators such as acids and salts including acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and salts of the foregoing acids. Mouth moisteners can include hydrocolloid materials that hydrate and can adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin (in addition to the pectin utilized in the second confectionery material), gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination thereof. Modified celluloses can be included such as microcrystalline cellulose, carboxymethylcellulose (CMC), methylcellulose (MC), hydroxypropylmethylcellulose (HPMC), hydroxypropylcellulose (MPC), or a combination thereof.

Similarly, humectants, which can provide a perception of mouth hydration, can be included. Such humectants can include glycerol, sorbitol, polyethylene glycol, erythritol, xylitol, and combinations thereof. Additionally, in some embodiments, fats can provide a perception of mouth moistening. Such fats can include medium chain triglycerides, vegetable oils, fish oils, mineral oils, and combinations thereof.

Suitable acidulants illustratively include acetic acid, citric acid, fumaric acid, hydrochloric acid, lactic acid and nitric acid as well as sodium citrate, sodium bicarbonate, sodium carbonate, sodium or potassium phosphate, magnesium oxide, potassium metaphosphate, sodium acetate, and combinations thereof.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof.

In some embodiments, a tingling sensation can be provided. Tingling agents include jambu, and alkylamides extracted from materials such as jambu or sanshool.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include, hydrolytic agents including proteolytic enzymes, abrasives such as hydrated silica, calcium carbonate, sodium bicarbonate and alumina, other active stain-removing components such as surface-active agents, including anionic surfactants such as sodium stearate, sodium palmitate, sulfated butyl oleate, sodium oleate, salts of fumaric acid, glycerol, hydroxylated lecithin, sodium lauryl sulfate, and chelators such as polyphosphates, which are typically employed as tartar control ingredients. Oral care ingredients can also include tetrasodium pyrophosphate and sodium tri-polyphosphate, sodium bicarbonate, sodium acid pyrophosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphosphate, and combinations thereof. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents include detersive materials that impart to the composition detersive and foaming properties. Suitable surfactants include sodium stearate, sodium ricinoleate, sodium lauryl sulfate, water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolammonium salts of N-lauroyl sarcosine, N-myristoyl sarcosine, and N-palmitoyl sarcosine.

In addition to surfactants, oral care ingredients can include antibacterial agents such as triclosan, chlorhexidine, zinc citrate, silver nitrate, copper, limonene, cetyl pyridinium chloride, and combinations thereof.

Anticaries agents can include fluoride ion sources such as sodium fluoride, potassium fluoride, sodium fluorosilicate, ammonium fluorosilicate, potassium fluoride, sodium monofluorophosphate, stannous fluoride, potassium stannous fluoride, sodium hexafluorostannate, stannous chlorofluoride, and combinations thereof.

Further examples of anticaries agents are included in U.S. Pat. No. 5,227,154 to Reynolds, U.S. Pat. No. 5,378,131 to Greenberg, and U.S. Pat. No. 6,685,916 to Holme et al.

Throat care or throat-soothing ingredients include analgesics, antihistamines, anesthetics, demulcents, mucolytics, expectorants, antitussive, and antiseptics. In some embodiments, throat-soothing agents include honey, propolis, aloe vera, glycerine, menthol and a combination thereof is employed.

Medicaments can be included in the multi-region confection as a component of the first or the second confectionery material. Non-limiting illustrative categories and specific examples include antihistamines, decongestants (sympathomimetics), antitussives (cough suppressants), expectorants, anesthetics, analgesics, demulcents, antibacterial agents, antiviral agents, anti-inflammatories, antacids, antifungal agents, chemotherapeutics, diuretics, psychotherapeutic agents, homeopathic agents, anticholinergics, throat-soothing agents, antinauseants, cardiovascular agents, various alkaloids, laxatives, appetite suppressants, ACE-inhibitors, anti-asthmatics, anti-cholesterolemics, anti-depressants, anti-diarrhea preparations, anti-hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants, osteoporosis preparations, oxytocics, parasympatholytics, parasympathomimetics, prostaglandins, respiratory agents, sedatives, smoking cessation aids such as bromocryptine or nicotine, tremor preparations, urinary tract agents, anti-ulcer agents, anti-emetics, hyper- and hypo-glycemic agents, thyroid and anti-thyroid preparations, terine relaxants, erythropoietic drugs, mucolytics, DNA and genetic modifying drugs, and nutritional supplements, including nutraceuticals, micronutrients, vitamins and co-enzymes. The pharmaceutically acceptable salts and prodrugs of the medicaments are also included unless specified otherwise. Some of these medicaments can serve more than one purpose. Combinations of the foregoing types of optional medicaments can be used. Two or more medicaments that have activity against the same or different symptoms can be used together in a combination.

Medicaments for the treatment of a cough, or a cold or flu symptom include elements, compounds or materials, alone or in combination, that have been used for, or have been shown to be useful for, the amelioration of at least one symptom commonly associated with cough, colds, or influenza. It is to be understood that a “medicament for the treatment of a cough, or a cold or flu symptom” includes medicaments that are also useful for the treatment of cold-like or flu-like symptoms arising from other sources, such as allergies, adverse environmental conditions, and the like. Cold, cold-like, flu, and flu-like symptoms as used herein include cough, coryza, nasal congestion, upper respiratory infections, allergic rhinitis, otitis, sinusitis, sneezing, and the discomfort, pain, fever and general malaise associated with colds, flu, allergies, adverse environmental conditions, and the like.

Examples of general categories of medicaments for the treatment of a cough, or a cold or flu symptom include antihistamines, decongestants (sympathomimetics), antitussives (cough suppressants), anti-inflammatories, homeopathic agents, expectorants, anesthetics, demulcents, analgesics, anticholinergics, throat-soothing agents, antibacterial agents, and antiviral agents. Some of these medicaments can serve more than one purpose. The pharmaceutically acceptable salts and prodrugs of the medicaments are also included unless specified otherwise. Two or more medicaments that have activity against the same or different symptoms of colds or coughs can be used together in a combination.

Exemplary antihistamines include azatadine, bromodiphenhydramine, brompheniramine, brompheniramine maleate, carbinoxamine, carbinoxamine maleate, cimetidine, chlorpheniramine, chlorpheniramine maleate, dexchlorpheniramine, diphenhydramine, diphenhydramine hydrochloride, doxylamine, phenindamine, pheniramine, phenyltoloxamine, pyrilamine, promethazine, triprolidine, loratadine, ranitidine, chlorcyclizine, terfenadine, clemastine fumarate, dimenhydrinate, prilamine maleate, tripelennamine hydrochloride, tripelennamine citrate, hydroxyzine pamoate, hydroxyzine hydrochloride, cyclizine lactate, cyclizine hydrochloride, meclizine hydrochloride, acrivastine, cetirizine hydrochloride, astemizole, levocabastine hydrochloride, cetirzine, and combinations thereof.

Exemplary decongestants include agents such as levopropoxyphene napsylate, noscapine, carbetapentane, caramiphen, chlophedianol, pseudoephedrine hydrochloride, phenylephrine, phenylpropanolamine, diphenhydramine, glaucine, pholcodine, benzonatate, ephedrine, ephinephrine, levodesoxyephedrine, oxymetazoline, naphazoline, propylhexedrine, xylometazoline, and combinations thereof.

Antitussives help relieve coughing. Examples of antitussives include codeine, dihydrocodeine, hydrocodone and hydromorphone, carbetapentane, caramiphen, hydrocodone bitartrate, chlorphedianol, noscarpine, dextromethorphan, and combinations thereof.

Expectorants include guaifenesin, aniseed, blood root, coltsfoot, elderflower, golden seal, grindelia, hyssop, lungwort, mullein, senega, thuja, thyme, vervain, glyceryl guaiacolate, terpin hydrate, N-acetylcysteine, bromhexine, ambroxol, domiodol, 3-iodo-1,2-propanediol and wild cherry, ammonium chloride, calcium iodide, iodinated glycerol, potassium guaiacolsulfonate, potassium iodide, sodium citrate, and combinations thereof.

Anaesthetics include etomidate, ketamine, propofol, and benodiazapines (e.g., chlordiazepoxide, diazepam, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocalne, procaine, proparcaine, ropivacaine, tetracaine, and combinations thereof. Other useful agents can include amobartital, aprobarbital, butabarbital, butalbital mephobarbital, methohexital, pentobarbital, phenobarbital, secobarbital, thiopental, paral, chloral hydrate, ethchlorvynol, clutethimide, methprylon, ethinamate, meprobamate, and combinations thereof.

Analgesics include opioids such as morphine, mepidine, dentanyl, sufentranil, alfentanil, aspirin, salicylamide, sodium salicylate, acetaminophen, ibuprofen, indomethacine, naproxen, atrin, isocome, midrin, axotal, firinal, phrenilin, ergot and ergot derivatives (wigraine, cafergot, ergostat, ergomar, dihydroergotamine), imitrex, and combinations thereof.

Anticholinergics include homatropine, atropine, scopolamine hydrogen bromide, L-hyoscyamine, L-alkaloids of belladonna, tincture of belladonna alkaloids, homatropine hydrogen bromide, homatropine methylbromide, methscopolamine, anisotropine, anisotropine with phenobarbital, clindinium, glycopyrrolate, hexocyclim, isopropamide, mepenzolate, methantheline, oxyphencyclimine, propantheline, tridihexethyl, dicyclomine, scopolamine, atropine, dicyclomine, flavoxate, ipratropium, oxybutynin, pirenzepine, tiotropium, tolterodine, tropicamide, trimethaphan, atracurium, doxacurium, mivacurium, pancuronium, tubocurarine, vecuronium, suxamethonium chloride, and combinations thereof.

Demulcents include coltsfoot, comfrey, corn silk, couchgrass, flaxseed, irish moss, lungwort, liquorice, mallow, marshmallow, mullein, oatmeal, parsley piert, slippery elm, and combinations thereof.

Antibacterial agents include those within the antibiotic classes of aminoglycosides, cephalosporins, macrolides, penicillins, quinolones, sulfonamides, and tetracyclines. Specific exemplary antibiotic agents include naficillin, oxacillin, vancomycin, clindamycin, erythromycin, trimethoprim-sulphamethoxazole, rifampin, ciprofloxacin, broad spectrum penicillin, amoxicillin, gentamicin, ceftriazoxone, cefotaxime, chloramphenicol, clavunate, sulbactam, probenecid, doxycycline, spectinomycin, cefixime, penicillin G, minocycline, β-lactamase inhibitors; meziocillin, piperacillin, aztreonam, norfloxacin, trimethoprim, ceftazidime, dapsone, neomycin, azithromycin, clarithromycin, amoxicillin, ciprofloxacin, and vancomycin.

Antiviral agents specifically or generally modulate the biological activity of viruses such as picornavirus, influenza virus, herpes viruses, herpes simplex, herpes zoster, enteroviruses, varicella and rhinovirus, which are associated with the common cold. Exemplary antiviral agents include acyclovir, trifluridine, idoxorudine, foscarnet, ganciclovir, zidovudine, dideoxycytosine, dideoxyinosine, dipyridamole, stavudine, cidofovir, famciclovir, valaciclovir, valganciclovir, acyclovir, didanosine, zalcitabine, rifimantadine, saquinavir, indinavir, ritonavir, ribavarin, nelfinavir, adefovir, nevirapine, delavirdine, efavirenz, abacavir, amantadine, emtricitabine, entecavir, tenofovir, zanamivir, oseltamivir, ICI 130,685, impulsin, pleconaril, penciclovir, vidarabine, cytokines, and combinations thereof.

Anti-inflammatories include salicylic acid derivatives including aspirin, paraminophenol derivatives including acetaminophen, indole and indene acetic acids including indomethacin, sulindac and etodalac, heteroaryl acetic acids including tolmetin diclofenac and ketorolac, aryl propionic acid derivatives including ibuprofen, naproxen, ketoprofen, fenopren, ketorlac, carprofen, oxaprozine, anthranilic acids including mefenamic acid, meclofenamic acid, and enolic acids including piroxicam, tenoxicam, phenylbutazone and oxyphenthatrazone.

Antacids include cimetidine, ranitidine, nizatidine, famotidine, omeprazole, bismuth antacids, metronidazole antacids, tetracycline antacids, clarthromycin antacids, hydroxides of aluminum, magnesium, sodium bicarbonates, calcium bicarbonate and other carbonates, silicates, phosphates, and combinations thereof.

Antifungal agents include, for example, ketoconazole, fluconazole, nystatin, itraconazole, clomitrazole, natamycin, econazole, isoconazole, oxiconazole, thiabendazole, tiaconazole, voriconazole, terbinafine, amorolfine, micfungin, amphotericin B, and combinations thereof.

Chemotherapeutics agents include cisplatin (CDDP), procarbazine, mechlorethamine, cyclophosphamide, camptothecin, ifosfamide, melphalan, chlorambucil, bisulfan, nitrosurea, dactinomycin, daunorubicin, doxorubicin, bleomycin, plicomycin, mitomycin, etoposide (VP16), tamoxifen, taxol, transplatinum, 5-fluorouracil, vincristin, vinblastin and methotrexate and analogs or derivative variants thereof, and combinations thereof.

Diuretics include but are not limited to acetazolamide, dichlorphenamide, methazolamide, furosemide, bumetanide, ethacrynic acid torseimde, azosemide, muzolimine, piretanide, tripamide, bendroflumethiazide, benzthiazide, chlorothiazide, hydrochlorothiazide, hydroflumethiazide, methyclothiazide, polythiazide, trichlormethiazide, indapamide, metolazone, quinethazone, amiloride, triamterene, sprionolactone, canrenone, potassium canrenoate, and combinations thereof.

Psychotherapeutic agents include thorazine, serentil, mellaril, millazine, tindal, permitil, prolixin, trilafon, stelazine, suprazine, taractan, navan, clozaril, haldol, halperon, loxitane, moban, orap, risperdal, alprazolam, chlordiaepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, welibutrin, serzone, desyrel, nardil, parnate, eldepryl, and combinations thereof.

Appetite suppressants include benzphetamine, diethylpropion, mazindol, phendimetrazine, phentermine, hoodia, ephedra, and caffeine. Additional appetite suppressant are commericailly under the following trade names: Adipex, Adipost, Bontril PDM, Bontril Slow Release, Didrex, Fastin, Ionamin, Mazanor, Melfiat, Obenix, Phendiet, Phendiet-105, Phentercot, Phentride, Plegine, Prelu-2, Pro-Fast, PT 105, Sanorex, Tenuate, Sanorex, Tenuate, Tenuate Dospan, Tepanil Ten-Tab, Teramine, Zantryl and combinations thereof.

Nutraceuticals and micronutrients include herbs and botanicals such as aloe, bilberry, bloodroot, calendula, capsicum, chamomile, cat's claw, echinacea, garlic, ginger, ginko, goldenseal, various ginseng, green tea, golden seal, guarana, kava kava, lutein, nettle, passionflower, rosemary, saw palmetto, St. John's wort, thyme, valerian, and combinations thereof. Also included are mineral supplements such as calcium, copper, iodine, iron, magnesium, manganese, molybdenum, phosphorous, zinc, selenium, and combinations thereof. Other nutraceuticals that can be added include fructo-oligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Vitamins and co-enzymes include water or fat-soluble vitamins such as thiamin, riboflavin, nicotinic acid, pyridoxine, pantothenic acid, biotin, folic acid, flavin, choline, inositol and paraminobenzoic acid, carnitine, vitamin C, vitamin D and its analogs, vitamin A and the carotenoids, retinoic acid, vitamin E, vitamin K, vitamin B₆, vitamin B₁₂, and combinations thereof. Combinations comprising at least one of the foregoing nutraceuticals can be used.

The amount of medicament or its acid addition salt used in the first and/or second confectionery material varies depending upon the therapeutic dosage recommended or permitted. In general, the amount of medicament present is the ordinary dosage used in the treatment of cough, or cold or flu symptoms. Such dosages are known to the skilled practitioner.

Specific optional, additional medicaments that can be used include caffeine, cimetidine, ranitidine, famotidine, omeprazole, dyclonine, nicotine, and combinations thereof.

Anti-oxidants include natural and artificial anti-oxidants like beta-carotenes, acidulants e.g. Vitamin C, propyl gallate, butyl hydroxyanisole, butylated hydroxytoluene, Vitamin E, Carnosic acid, Rosmanol, rosmaridiphenol, etc.

Preservatives include any natural and synthetic preservatives that improve shelf life of a confectionery product. Suitable preservatives include propanoic acid, benzoic acid, and sorbic acid.

The relative amounts of each of the components of the multi-region confection will depend on the identity of the particular component of the confection composition, as well as, the desired flavor of the confection, and are readily determined by one of ordinary skill in the art.

The extruded body portion of the multi-region confection comprises a plurality of capillaries. It should be understood that the term “plurality” is intended to mean two or more. In some embodiments, a plurality is 3 or more, or 4 or more, or 5 or more, or 6 or more, or 7 or more. There is no particular upper limit on the number associated with “plurality”.

It should be understood that the term “capillary” generally refers to a conduit or space created within the body of the product by an extrusion or other forming process. The capillary typically contains matter, and that matter can be in the form of a gas, a liquid, a solid, or a mixture thereof.

The plurality of capillaries disposed in the extruded body portion of the first confectionery material can have any suitable dimensions. Typically, the capillaries have an approximately circular cross-section. In some embodiments, the plurality of capillaries have a width or diameter of about 0.1 to about 5 millimeters. Within the range of about 0.1 to about 5 millimeters, the capillaries can have a width or diameter of about 0.2 to about 4 millimeters, specifically the capillaries can have a width or diameter of about 0.5 to about 3 millimeters, more specifically the capillaries can have a diameter of about 0.7 to about 1.2 millimeters.

The capillaries may extend along the substantially entire length of the body portion, but may in some embodiments extend about 75%, 80%, 90%, or 95% along the length of the body portion (for example, when it is desired to seal the ends of the body portion). When the capillaries extend along the entire length of body portion, suitably the ends of the capillaries are visible at one or more ends of the body portion.

In some embodiments, there is provided a multi-region confection, wherein the second confectionery material comprises about 75 to about 85 weigh percent of the sugar alcohol, wherein the sugar alcohol comprises xylitol and erythritol; about 3 to about 7 weight percent of water; and about 0.3 to about 0.6 weight percent of the slow-set pectin, wherein the slow-set pectin has a degree of methoxylation of about 57 to about 63; wherein the second confectionery material further comprises about 7 to about 9 weight percent of a food grade fat comprising hydrogenated vegetable oil; and about 0.6 to about 1 weight percent of an emulsifier comprising a sucrose stearate.

In one embodiment, there is provided a method of forming a multi-region confection, comprising extruding a first confectionery material to form an extruded body portion and a plurality of capillaries disposed in the extruded body portion; and extruding a second confectionery material into at least one of the plurality of capillaries; wherein the second confectionery material comprises about 47 to about 95 weight percent of a sugar alcohol, about 1 to about 15 weight percent water, and about 0.1 to about 1.5 weight percent of a slow-set pectin, wherein all weight percent values are based on the total weight of the second confectionery material, unless a different weight basis is specified.

The first and the second confectionery materials can be extruded at suitable temperatures depending upon the melting point, viscosity and flow properties of the materials at selected temperatures. In some embodiments, the method comprises extruding the second confectionery material at a temperature of about 50° C. to about 150° C. Within the range of about 50° C. to about 150° C., the temperature can be about 70° C. to 130° C., specifically about 80° C. to 120° C. and more specifically about 90° C. to 110° C. In some embodiments, the method comprises extruding the first confectionery material at a temperature of about 50° C. to about 90° C.

The extrusion temperatures of the first confectionery material and the second confectionery material can be different. In some embodiments, the method of forming multi-region confections comprises extruding the first confectionery material at a temperature lower than the temperature of the second confectionery material. In some other embodiments, the method comprises extruding the first confectionery material at a temperature higher than the temperature of the second confectionery material.

In yet other embodiments, the first and the second confectionery materials are extruded at the same temperature.

The second confectionery material is typically in a plastic state so that it can be extruded through a capillary die. The second confectionery material can be in liquid state, or in semi-solid or gel form during the extrusion process. The second confectionery material can solidify after extrusion. In some embodiments, the method of making multi-region confection comprises extruding the second confectionery material in a liquid state and cooling the second confectionery material until it solidifies and/or crystallizes. In some other embodiments, the method comprise extruding the second confectionery material in a plastic solid state and cooling the multi-region confectionery to crystallize the second confectionery material.

Similarly, the first confectionery material is typically in a plastic state so that it can be extruded through a confectionery-forming die. The first confectionery material can also be in gel form or soft-chew candy malleable solid form during the extrusion process.

Various components of the second confectionery material may be simultaneously blend or in some instances certain components are pre-blended. In some embodiments, the second confectionery composition is a product of a process comprising pre-blending about 1 to about 5 weight percent of the sugar alcohol, and about 0.1 to about 1.5 weight percent of the pectin to form a pectin-slurry; and blending the pectin-slurry with the remaining sugar alcohol. The weight percentages are based on the total weight of the second confectionery material.

It has been surprisingly found that pre-blending reduces the amount of water required to dissolve the pectin, which in turn reduces the moisture content of the second confectionery material, thereby enhancing crunchy texture of the capillaries formed out of the second confectionery material. It is generally undesirable to have high water content in the second confectionery material, since it would lead to leaks. If the second confectionery material is heated to a very high temperature to evaporate water, the heat can damage pectin. It has been surprisingly found that pre-blending the sugar alcohol with the pectin avoid the problems described above and enhances crunchy texture of the second confectionery material.

The invention is further illustrated by the following non-limiting examples.

### EXAMPLES

Five examples of multi-region confections were prepared. Compositions of the five examples are listed in Table 1. Example 1 and Example 2 were multi-region confections according to embodiments of the invention, while Comparison 1, Comparison 2 and Comparison 3 were examples not according to the invention. Multiple samples were prepared for each example type.

Multi-region confections were prepared by co-extrusion of a first confectionery material and a second confectionery material. The first confection was a sugar-based soft chew candy composition with berry flavor available commercially under the brand name Pascall® Fruit Burst® from Cadbury (Kraft) Inc. Any other candy composition can be used as a first confectionery material. First confectionery materials were the same for all example types. However, the second confectionery materials were different for each example type. Compositions of second confectionery materials used in various examples are listed in Table 1.

### Example 1

Example 1 was prepared by co-extrusion of the first confectionery material mentioned above, and a second confectionery material prepared by process described below.

To prepare the second confectionery material, 43.20 kilograms of xylitol powder was added to a jacketed vessel capable of heating its contents to at least 150° C. The jacketed vessel was coupled with a mechanical stirrer to stir the contents of the jacketed vessel. The jacketed vessel was heated to 100° C. Then, 37.03 kilograms of erythritol powder was added to the jacketed vessel under constant stirring condition. Erythritol powder was purchased from Cargill Inc; it is also available from other suppliers like Mitsubishi Kagaku Foods. Xylitol powder was purchased from Danisco; it is also available from a number of suppliers, for example Roquette, Futian, and Hayashibara.

In a vertical mixer vessel, a slurry of xylitol, emulsifier, pectin, and water was prepared. The emulsifier was a sucrose stearate commercially available as Sugar Ester 5-1170® from Mitsubishi-Kagakau Food Corporation in powder form. The pectin was a high-methoxy pectin having a degree of methoxylation of about 57 to 63, commercially available from TIC Gums Inc. under the brand name TIC Pretested® Pectin HM Slow-set. To prepare the slurry, 2.06 kilograms of xylitol powder, 0.82 kilogram of sugar ester S-1170 powder and 0.41 kilogram of pectin powder were weighed and added to a plastic bag. The powder ingredients were mixed by hand using a spatula for two minutes. The powder mix was then added to 4.11 kilograms of water at 25° C. in the vertical mixer vessel under constant stirring conditions. The slurry was stirred for 30 minutes.

The slurry of xylitol, sugar ester, and pectin was then added to the jacketed vessel under constant stirring conditions. The temperature of the jacketed vessel was raised to 140° C. In a melting bin, 8.23 kilograms of food grade fat N'ICE 368 was added. N'ICE 368 is a fat of vegetable origin commercially available from Premium Vegetable Oils Sdn. Bhd, Kuala Lumpur, Malaysia. The melting bin was heated to 60° C. to melt the fat. Also, 4.115 kilograms of citric acid monohydrate was weighed and added to a second plastic bag for later addition to the jacketed vessel.

Molten fat N'ICE 368 from the melting bin was then added to the jacketed vessel under continuous stirring conditions. After 10 minutes, the temperature of the jacketed vessel was reduced to 130° C. and citric acid monohydrate from the second plastic bag was added to the vessel under continuous stirring conditions. Throughout the above process, the temperature of the jacketed vessel was maintained above 130° C. to avoid solidification or crystallization of the contents. The second confectionery material of Example 1 is thus prepared. The second confectionery material is then cooled down to 100° C. and fed to a co-extrusion apparatus described below.

### Example 2

Example 2 was prepared by co-extrusion of the first confectionery material mentioned above, and a second confectionery material prepared by the process described above. The composition of the second confectionery material of Example 2 is listed in Table 1.

### Comparison 1

Comparison 1 was prepared by co-extrusion of the first confectionery material mentioned above, and a second confectionery material prepared by the process described above. The composition of the second confectionery material of Comparison 1 is listed in Table 1. The gelling agent used in Comparison 1 was a low methoxy pectin, commercially available from TIC Gums under the brand name TIC Pretested® Pectin Rapid-set.

### Comparison 2

Comparison 2 was prepared by co-extrusion of the first confectionery material mentioned above, and a second confectionery material prepared by the process described above. The composition of the second confectionery material of comparison 2 is listed in Table 1. The gelling agent Konjac/Xanthan used in comparison 2 is a combination of Xanthan gum and glucomann made from Konjac plant. It is commercially available from TIC Gums Inc under the brand name Konjac/Xanthan Ticagel® Bind-KX.

### Comparison 3

Comparison 3 was prepared by co-extrusion of the first confectionery material mentioned above, and a second confectionery material prepared by the process described above. The composition of the second confectionery material of Comparison 3 is listed in Table 1.

TABLE 1
Compositions of multi-region confections

| | Comparison 1 | Comparison 2 | Comparison 3 | Example 1 | Example 2 |
|---|---|---|---|---|---|
| Compositions of first | Fruit Burst | Fruit Burst | Fruit Burst | Fruit Burst | Fruit Burst |
| confectionery | Soft chew | Soft chew | Soft chew | Soft chew | Soft chew |
| materials | candy | candy | candy | candy | candy |

Compositions of second Confectionery Materials#

| | | | | | |
|---|---|---|---|---|---|
| (i) Sugar Alcohols | | | | | |
| Xylitol | 43.54 | 43.44 | 45.74 | 43.20 | 43.44 |
| Erythritol | 37.3 | 37.2 | 39.1 | 37.03 | 37.2 |
| (ii) Gelling agent- | | | | | |
| Emulsifier Blend | | | | | |
| HM Pectin Rapid-set | 0.40 | 0.00 | 0.00 | 0.00 | 0.00 |
| Konjac/Xantan | 0.00 | 0.80 | 0.00 | 0.00 | 0.00 |
| HM Pectin Slow-set | 0.00 | 0.00 | 0.00 | 0.41 | 0.8 |
| Water | 8.3 | 8.3 | 4.3 | 4.11 | 8.3 |
| Xylitol | 2.06 | 2.06 | 2.06 | 2.06 | 2.06 |
| Sugar Ester S-770 | 0.2 | 0.2 | 0.2 | 0.82 | 0.2 |
| (iii) Hydrogenated Fat | | | | | |
| N'ICE 368 | 3.9 | 3.9 | 4.1 | 8.23 | 3.9 |
| (iv) Acids | | | | | |
| Citric Acid | 4.1 | 4.1 | 4.3 | 4.15 | 4.1 |
| Monohydrous | | | | | |

#amounts in weight percent of the second confectionery material

### Preparation of Multi-region Confectionery Materials

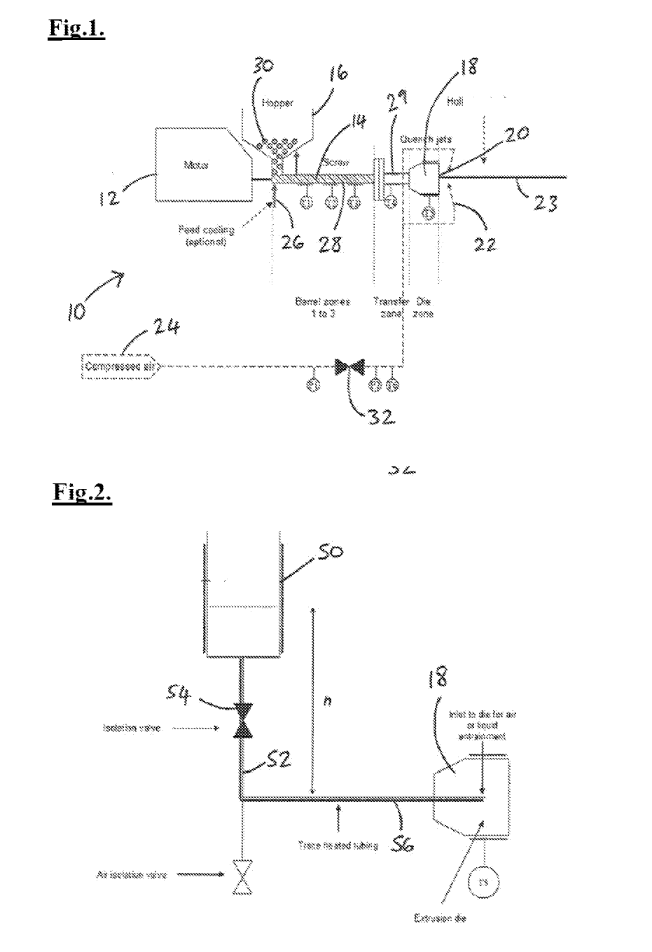

Multi-region confections described above were prepared by co-extrusion of first and second confectionery materials. The extrusion equipment consisted of a Betol single screw extruder, with a screw diameter of approximately 12 millimeters, and a screw length to diameter ratio of roughly 22.5:1. The extruder had four different temperature zones (denoted T1-T4 in FIG. 1 as described later), each of which could be independently controlled using proportional integral derivative controllers connected to band heaters. The Mk 3 MCF extrusion die, containing an entrainment array consisting of 17 hypodermic needles, was connected on the extruder endplate. Two opposed air jets, used to rapidly cool the extrudate emerging from the extrusion die, were placed above and below the die exit; these jets were connected via a valve to a compressed air line at 7×10⁵ Newton per square meters. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed toward the die outlet 20 so as to cool the extruded material 23, and these jets are fed with compressed air 24. If desired, the area of the apparatus where the hopper 16 is coupled to the screw 14 can be cooled by means of a cooling feed 26.

Surrounding the screw 14 is a barrel 28, which has three barrel temperature zones denoted T1 to T3—the temperatures of each zone can be controlled independent of other zones. The barrel 28 is connected to the die 18 by means of a feed conduit 29 which has a temperature zone T4 which can be controlled.

In use, the hopper 16 is filled with first confectionery material 30 which can be heated so as to maintain it as a liquid. Before the first confectionery material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature adjusted again (if required) by temperature control T4 before entering the die 18.

With reference to FIG. 2, there is shown a schematic diagram of the extrusion die assembly used together with the apparatus of FIG. 1 for preparing various multi-region confections. Reservoir 50 holds the second confectionery material. The reservoir 50 is heated so that the second confenctionery material is maintained at correct temperature so as to maintain it in liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having a number of needles, so that when the first confectionery material is being extruded, the capillaries formed around the needles can be simultaneously filled with the second confectionery material.

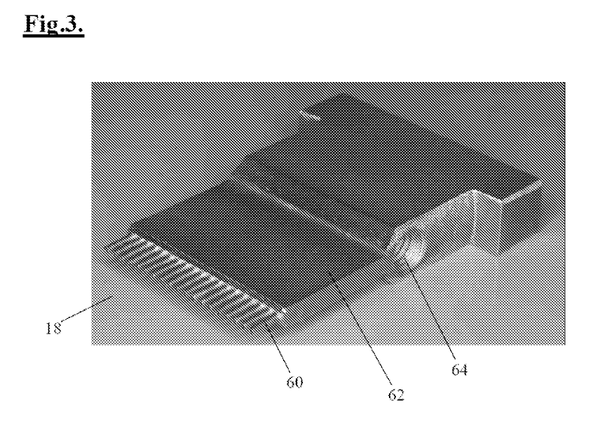

FIG. 3 shows the die 18 in more detail. In particular, this figure shows that the metallic die 18 has, at one end, a plurality of needles 60 which are joined to a cavity 62 which is in fluid communication with an inlet channel 64 for pumping a second confectionery material into the needles 60. While the first confectionery material is being extruded, second confectionery is forced through the needles so that the extrudate contains a number of capillaries filled with the second confectionery material. The extrudate 23 is cooled by means of the quench jets 22 as it is released from the die 18.

The extrudates of multi-region confections were formed in shapes of ropes. Ropes were cut to form rope samples each having a length of 40 centimeters and a square cross section with a side of 2 centimeters. One such rope for each example-type was allowed to age at room temperature for 3 days. Also, for each Example type one rope was cut into shorter pieces, each piece had a length of 2 centimeters. The pieces were individually wrapped in plastic wrappers. The wrapped pieces were then allowed to age at room temperature (25° C.) for 3 days. Similarly, one piece for each example-type was allowed to age for 3 days without wrapping.

### Visual and Sensory Evaluation of Multi-Region Confections

The rope and piece samples of each example-type were visually evaluated at the end of 3 days for degree of crystallization and degree of leaking of the second confectionery material from the capillaries. These evaluations were conducted visually to obtain qualitative assessments.

At the end of three days, the piece samples were cut along a plane perpendicular to the length of the piece to inspect inside of the pieces. The inside of the piece samples were visually inspected for degree of crystallization and degree of leak of the second confectionery material. The results are summarized in Tables 2 and 3.

TABLE 2
Physical Properties of Rope Samples upon Aging

| PROPERTIES | Comparison 1 | Comparison 2 | Comparison 3 | Example 1 | Example 2 |
|---|---|---|---|---|---|
| Degree of | | | | | |
| crystallization^{#1} | | | | | |
| 1 hr | Liquid. No | Liquid. No | Liquid. No | Liquid. No | Liquid. No |
| | crystallization | crystallization | crystallization | crystallization | crystallization |
| 3 hr | Liquid. No | Liquid. No | Liquid. No | Liquid. No | Liquid. No |
| | crystallization | crystallization | crystallization | crystallization | crystallization |
| 3 days | Very Little | Very Little | Crystals | Crystals | Crystals |
| | crystallization; | crystallization; | formed | formed | formed |
| | Mostly liquid | Mostly liquid | | | |
| Degree of leak of | | | | | |
| second confectionery | | | | | |
| material after aging at | | | | | |
| room temperature for- | | | | | |
| 1 hr | Leaks easily | Leaks easily | Leaks easily | No | Viscous, leaks |
| | | | | spontaneous | very slowly |
| | | | | leaks | |
| 3 hr | Leaks easily | Leaks easily | Leaks easily | No | Viscous, leaks |
| | | | | spontaneous | very slowly |
| | | | | leaks | |
| 3 days | No spontaneous | No spontaneous | No | No | No |
| | leaks | leaks | spontaneous | spontaneous | spontaneous |
| | | | leaks | leaks | leaks |

^{#1}Degree of crystallization of second confectionery material on aging at room temperature for selected time interval

TABLE 3
Physical Properties of Piece Samples upon Aging for 3 days at room temperature

| | Comparative | | Comparative | | Comparative | | Inventive | | Inventive | |
|---|---|---|---|---|---|---|---|---|---|---|
| | Ex. 1 | | Ex. 2 | | Ex 3 | | Ex. 1 | | Ex. 2 | |
| | with | without | with | without | with | without | with | without | with | without |
| Properties | wrap | wrap | wrap | wrap | wrap | wrap | wrap | wrap | wrap | wrap |
| On Cutting | Leaks | Leaks | Leaks | Leaks | Leaks | Leaks | No | No | No | No |
| | | | | | | | Leaks | leaks | leaks | leaks |
| Crystals | No | Yes | No | Yes | No | Very | Yes | Yes | Yes | Yes |
| formed inside | | | | | | little | | | | |
| the piece | | | | | | | | | | |

From the above results, it can be clearly observed that the inventive compositions prevent leaking in multi-region confectioneries. In a sensory evaluation by twelve expert evaluators, the inventive compositions were also found to possess a crunchy texture. Thus, the inventive compositions and process of making the compositions enable preparation of leak-free, crunchy multi-region confections.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A multi-region confection comprising:
an extruded body portion comprising a first confectionery material; and
a plurality of capillaries disposed in the extruded body portion and comprising a second confectionery material comprising
about 47 to about 95 weight percent of a sugar alcohol,
about 1 to about 15 weight percent water, and
about 0.1 to about 1.5 weight percent of a slow-set pectin;
wherein all weight percent values are based on the total weight of the second confectionery material, unless a different weight basis is specified.

2. The multi-region confection of claim 1, wherein the slow-set pectin is a pectin having a degree of methoxylation of about 50 to about 70 percent.

3. The multi-region confection of claim 1, wherein said sugar alcohol is selected from the group consisting of erythritol, xylitol, mannitol, galactitol, maltitol, hydrogenated isomaltulose (isomalt), sorbitol, lactitol, hydrogenated starch hydrolysate, and combinations thereof.

4. The multi-region confection of claim 1, wherein the second confectionery material comprises about 75 to about 91 weight percent of the sugar alcohol.

5. The multi-region confection of claim 1, wherein the second confectionery material comprises about 79 to about 85 weight percent of the sugar alcohol.

6. The multi-region confection of claim 1, wherein the second confectionery material comprises about 0.2 to about 1.3 weight percent of the slow-set pectin.

7. The multi-region confection of claim 1, wherein the second confectionery material comprises about 0.3 to about 1.1 weight percent of the slow-set pectin.

8. The multi-region confection of claim 1, wherein the second confectionery material further comprises about 1 to about 50 weight percent of a food-grade fat or oil.

9. The multi-region confection of claim 8, wherein the second confectionery material further comprises an emulsifier in an amount of about 5 to about 20 weight percent, based on the weight of the food-grade fat or oil.

10. The multi-region confection of claim 1, wherein the second confectionery material further comprises a food-grade acid.

11. The multi-region confection of claim 1, wherein the first confectionery material is selected from the group consisting of a hard-boiled candy composition, a chewy candy composition, and a chewing gum composition.

12-13. (canceled)

14. The multi-region confection of claim 1, wherein the plurality of capillaries have a width or diameter of about 0.1 to about 5 millimeters.

15. The multi-region confection of claim 1,
wherein said second confectionery material comprises
about 75 to about 85 weigh percent of the sugar alcohol, wherein the sugar alcohol comprises xylitol and erythritol;
about 3 to about 7 weight percent of water; and
about 0.3 to about 0.6 weight percent of the slow-set pectin, wherein the slow-set pectin has a degree of methoxylation of about 57 to about 63; and
wherein the second confectionery material further comprises
about 7 to about 9 weight percent of a food grade fat comprising a hydrogenated vegetable oil; and
about 0.6 to about 1 weight percent of an emulsifier comprising a sucrose stearate.

16. A method of forming a multi-region confection, comprising:
extruding a first confectionery material to form an extruded body portion and a plurality of capillaries disposed in the extruded body portion; and
extruding a second confectionery material into at least one of the plurality of capillaries;
wherein the second confectionery material comprises
about 47 to about 95 weight percent of a sugar alcohol,
about 1 to about 15 weight percent water, and
about 0.1 to about 1.5 weight percent of a slow-set pectin having a degree of methoxylation of about 50 to about 70 percent;
wherein all weight percent values are based on the total weight of the second confectionery material, unless a different weight basis is specified.

17. The method of claim 16, wherein said extruding a second confectionery material comprises extruding the second confectionery material at a temperature of about 50° C. to about 150° C.

18. The method of claim 16, wherein said extruding a second confectionery material comprises extruding the second confectionery material at a temperature of about 70° C. to about 130° C.

19. The method of claim 16, wherein said extruding a first confectionery material comprises extruding the first confectionery material at a temperature lower than the temperature of the second confectionery material.

20. The method of claim 16, wherein said extruding a first confectionery material comprises extruding the first confectionery material at a temperature higher than the temperature of the second confectionery material.

21. The method of claim 16, wherein said extruding a second confectionery material comprises extruding the second confectionery material in a liquid state and cooling the second confectionery material until it solidifies and/or crystallizes.

22. The method of claim 16, wherein said second confectionery composition is a product of a process comprising
pre-blending about 1 to about 5 weight percent of the sugar alcohol, and about 0.1 to about 1.5 weight percent of the pectin to form a pectin-slurry; and
blending the pectin-slurry with the remaining sugar alcohol.

23. (canceled)
